(19) United States
(12) Patent Application Publication
(10) Pub. No.: US 2008/0316081 A1
(43) Pub. Date: Dec. 25, 2008

(54) BATTERY-FREE REMOTE CONTROL DEVICE

(75) Inventors: YUNG HUA CHEN, JHUBEI CITY (TW); SHAO CHANG CHANG, TAIPEI CITY (TW); YA-PING CHEN, JHUBEI CITY (TW)

Correspondence Address: Akin Gump LLP - Silicon Valley, 3000 El Camino Real, Two Palo Alto Square, Suite 400, Palo Alto, CA, 94306, US

(73) Assignee: FAVEPC, INC., JHUBEI CITY (TW)

(21) Appl. No.: 11/766,738

(22) Filed: Jun. 21, 2007

(51) Int. Cl. G08C 19/12

(52) U.S. Cl. 341/176

(57) ABSTRACT

A control device capable of controlling an electronic device via wireless communications, the control device comprising a first antenna capable of receiving a radio frequency (RF) carrier at a first frequency, a power generation circuit capable of converting RF power of the RF carrier into direct-current (DC) power, a plurality of input devices configured to allow adjustment of a number of settings of the electronic device, each of the input devices being related to one of the number of settings, a memory device configured to store a number of codes, each of the number of codes being related to one of the number of settings, a control unit configured to receive the DC power and capable of retrieving one of the number of codes in the memory device based on a selection of at least one of the input devices, and a modulator capable of modulating the one code at the first frequency.

### BACKGROUND OF THE INVENTION

This invention generally relates to an electronic device and, more particularly, to a battery-free remote control device configured to be powered by a controlled device.

Remote controls or remote controllers have been widely used for the remote operation of consumer electronics such as televisions, stereo systems, digital video disc (DVD) players and game consoles. A remote control may allow a user to control an electronic device located remotely or at a distance from the user through wireless communications. Generally, remote controls for these consumer electronics are low-profile, handheld devices and usually powered by small-size batteries such as AAA-sized or AA-sized batteries. For a user, however, battery replacement of the remote controls for their respective consumer electronics may be inconvenient. Furthermore, used or waste batteries, if not properly recycled, may cause environmental pollution. It may therefore be desirable to have a remote control that is able to operate without internal batteries.

### BRIEF SUMMARY OF THE INVENTION

One example consistent with the invention may provide a control device capable of controlling an electronic device via wireless communications, the control device comprising a first antenna capable of receiving a radio frequency (RF) carrier at a first frequency, a power generation circuit capable of converting RF power of the RF carrier into direct-current (DC) power, a plurality of input devices configured to allow adjustment of a number of settings of the electronic device, each of the input devices being related to one of the number of settings, a memory device configured to store a number of codes, each of the number of codes being related to one of the number of settings, a control unit configured to receive the DC power and capable of retrieving one of the number of codes in the memory device based on a selection of at least one of the input devices, and a modulator capable of modulating the one code at the first frequency.

Another example consistent with the invention may provide a control device capable of controlling an electronic device via wireless communications, the control device comprising a first antenna capable of receiving a carrier at a first frequency, the carrier having a first voltage level, a power generation circuit capable of providing a power supply with a second voltage level based on the carrier, the second voltage level being greater than the first voltage level, a number of input devices configured to allow adjustment of a number of settings of the electronic device, each of the number of input devices being related to one of the number of settings, a memory device configured to store a number of codes, each of the number of codes being related to one of the number of settings, a control unit configured to receive the power supply and capable of retrieving one of the number of codes in the memory device based on a selection of at least one of the input devices, and a modulator capable of modulating the one code at the first frequency.

In another example, the invention may provide a control device capable of controlling an electronic device via wireless communications, the control device comprising a first antenna capable of receiving a carrier at a first frequency, a power generation circuit capable of providing a power supply based on the carrier, a number of input devices corresponding to a number of settings of the electronic device, a memory device configured to store a number of codes, each of the number of codes being related to one of the number of settings, a control unit coupled to the power generation circuit, the control unit being capable of retrieving one of the number of codes in the memory device based on a selection of at least one of the input devices, and a modulator capable of modulating the one code at the first frequency.

In still another example, the invention may provide an electronic device capable of being controlled by a control device via wireless communications, the electronic device comprising a transmitter capable of generating a carrier signal to trigger the control device, an antenna capable of transmitting the carrier signal and receiving a control signal from the control device, the control signal including a code, a demodulator capable of demodulating the control signal, and a control unit capable of correlating the code to a setting of the electronic device.

In yet another example, the present invention may provide a method of controlling an electronic device from a control device via wireless communications, the method comprising receiving a radio frequency (RF) carrier signal from the electronic device, converting RF power of the carrier signal into direct-current (DC) power, triggering a control circuit of the control device based on the DC power, receiving a command to adjust a setting of the electronic device, and accessing a memory device of the control device for a code corresponding to the setting in response to the command.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended, exemplary drawings. It should be understood, however, that the invention is not limited to the precise arrangements and instrumentalities shown.

In the drawings:

FIG. 1A is a schematic block diagram of a control device in accordance with an example of the present invention;

FIG. 1B is a schematic diagram illustrating an operation of a memory device of the control device illustrated in FIG. 1A;

FIG. 2A is a simplified block diagram of an electronic device related to the control device illustrated in FIG. 1A in accordance with an example of the present invention; and

FIG. 2B is a schematic diagram illustrating an operation of a control unit of the electronic device illustrated in FIG. 2A.

### DETAILED DESCRIPTION OF THE INVENTION

Reference will now be made in detail to the present examples of the invention illustrated in the accompanying drawings. Wherever possible, the same reference numbers will be used throughout the drawings to refer to the same or like portions.

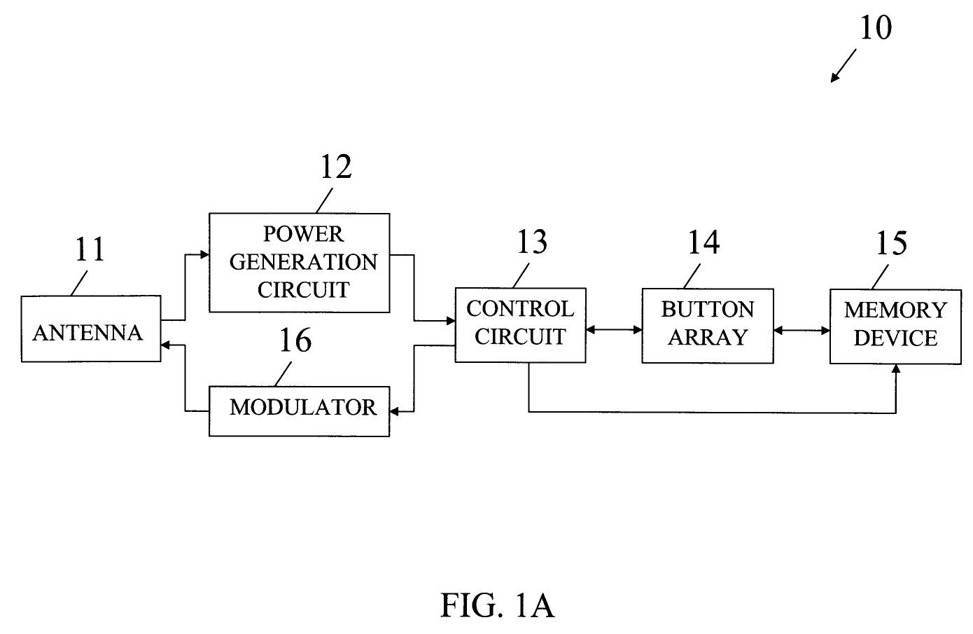

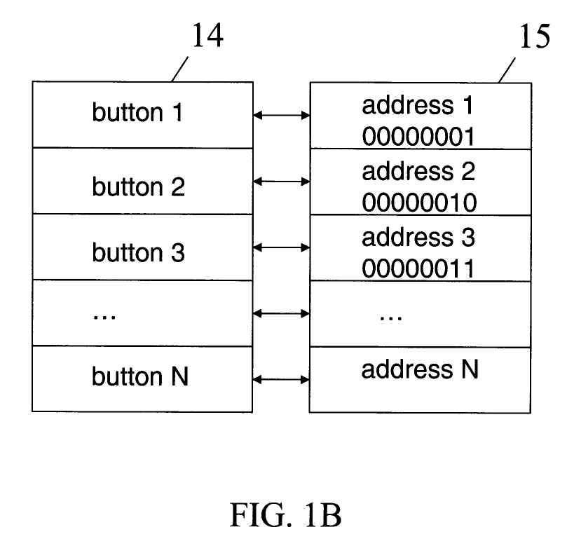

FIG. 1A is a schematic block diagram of a control device 10 in accordance with an example of the present invention. Referring to FIG. 1A, the control device 10 may include an antenna 11, a power generation circuit 12, a control circuit 13, an array of buttons 14, a memory device 15 and a modulator 16. The antenna 11 is coupled to power generation circuit 12, which in turn is coupled to control circuit 13. Antenna 11 is also coupled to modulator 16. Control circuit 13 is further coupled to button array 14, memory device 15 and modulator 16. Button array 14 is also coupled to memory device 15.

In operation, the antenna 11, for example, a dipole antenna, may be configured to receive a carrier signal or carrier wave from an electronic device to be remotely controlled by the control device 10. In one example according to the present invention, the control device 10 may operate, for example, at an ultra-high-frequency (UHF) band at or near 433 mega Hertz (MHz). In another example, the control device 10 may operate at a microwave band at or near 2.4 giga Hertz (GHz). Furthermore, the carrier signal transmitting at the UHF band from the electronic device may have a peak-to-peak amplitude of approximately 5 volts (V) or above, which may be reduced to approximately 0.3V when received at the control device 10 due to channel degradation. The received carrier signal is provided to the power generation circuit 12, which may be capable of converting the radio-frequency (RF) power of the carrier signal into direct-current (DC) power. The power generation circuit 12 in one example may include a charge pump, which may generate a higher voltage based on the input RF power of the carrier signal. In another example, the power generation circuit 12 may include an alternating-current (AC) to DC converter followed by a voltage multiplier. Furthermore, the power generation circuit 12 may generate a DC voltage of approximately 3.3V based on the carrier signal of approximately 0.3V and provide the DC power supply to the control circuit 13. Specifically, the power for the control circuit 13, the button array 14, the memory device 15 and the modulator 16 may come from the power generation circuit 12. The lack of an onboard power supply may mean that the control device 10 can be designed with a more low-profile and smaller size than a conventional remote control device.

The button array 14 may include a number of buttons to allow a user to adjust various settings of the electronic device by pressing at least one of the buttons. Button array 14 may also include, for example, switches, rockers, dials, knobs, scrollers, wheels, touch-sensitive surfaces or regions, and other input devices to allow the user to adjust settings. The various settings, depending on the particular functions provided by the electronic device, may involve, for example, television channel, disc number, track number, volume, brightness, color intensity and so forth. The memory device 15, for example, a non-volatile electrically erasable programmable read only memory (EEPROM) or a flash memory, may include data corresponding to the various settings.

FIG. 1B is a schematic diagram illustrating an operation of the memory device 15 of the control device 10 illustrated in FIG. 1A. Referring to FIG. 1B, the memory device 15 may include a number of codes stored at different addresses 1 to N, N being a natural number. Each of the codes, for example, an eight-bit code, may be related to one of the various settings and may be associated with a particular button from button array 14. In other examples, a particular code may be related to a setting that is accessible through a hierarchical menu and may thus be associated with a particular sequence of button presses or combination of button presses. Referring again to FIG. 1A, when the user pushes a button on the control device 10, a particular setting of the electronic device may be selected, and in turn a particular code at a particular address in the memory device 15 may be accessed. The control circuit 13 may retrieve the code and send the same to the modulator 16, which may be capable of modulating the code at the carrier frequency, for example, 433 MHz or 2.4 GHz. The antenna 11 may then transmit a modulated carrier including information on the selected setting to the electronic device. In one example, the control device 10 may issue a command or control signal by backscattering the carrier wave sent from the electronic device. That is, the antenna 11 may be configured to both collect power from the incoming carrier signal and also transmit the outgoing backscatter signal.

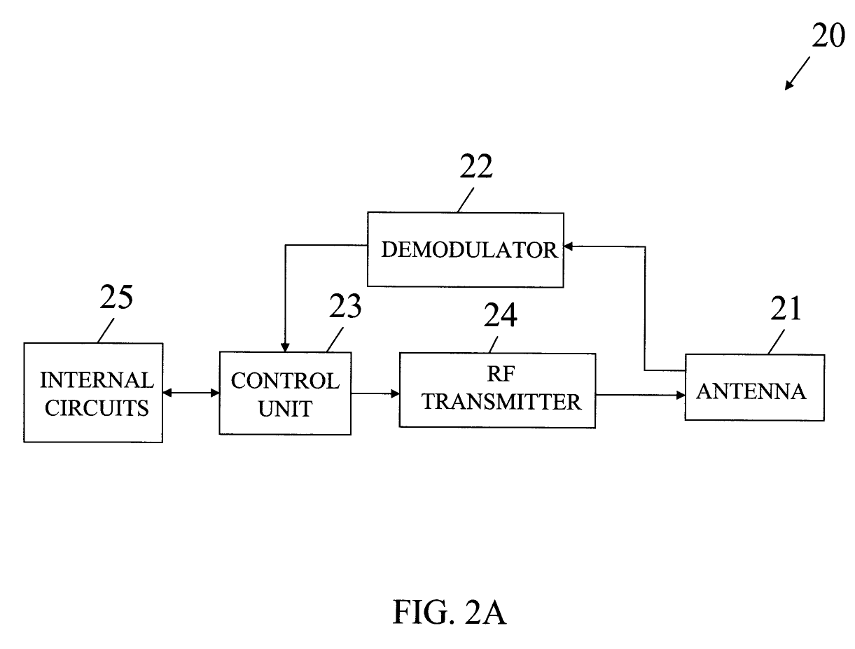

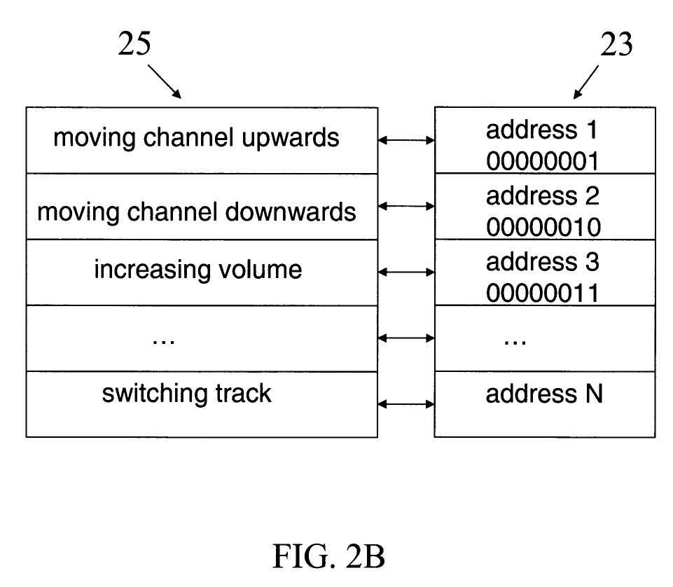

FIG. 2A is a simplified block diagram of an electronic device 20 related to the control device 10 illustrated in FIG. 1A in accordance with an example of the present invention. Referring to FIG. 1B, the electronic device 20 may include an antenna 21, a demodulator 22, a control unit 23, a radio frequency (RF) transmitter 24 and internal circuits 25. The antenna 21 is coupled to the demodulator 22 and RF transmitter 24. The control unit 23 is coupled to the demodulator 22, RF transmitter 24 and internal circuits 25. The electronic device 20 may be any device used in daily life such as a television, refrigerator, electrical fan, air conditioner, DVD player or game console, and may be located remotely or at a distance from the control device 10. Once the electronic device 20 is powered on, the RF transmitter 24 may generate a carrier signal or carrier wave at a predetermined frequency, for example, 433 MHz or 2.4 GHz. The antenna 21, for example, a dipole antenna, may be configured to transmit the carrier signal from the RF transmitter 24 and receive a control signal from the antenna 11. In one example according to the present invention, the RF transmitter 24 may continuously transmit the carrier signal through the antenna 21 once the electronic device 20 is powered on. The carrier signal may then trigger the control device 10 and allow the control device 10 to be ready for use by continuously charging the power generation circuit 12. The received control signal may then be demodulated at the demodulator 22.

FIG. 2B is a schematic diagram illustrating an operation of the control unit 23 of the electronic device 20 illustrated in FIG. 2A. Referring to FIG. 2B, a demodulated signal including the code or in turn the selected setting may be received at the control unit 23, which may be a micro-processor. The internal circuits 25, which may be configured to perform the particular functions of the electronic device 20, may operate based on the demodulated signal, for example, to move upwards or downwards channel, increase or decrease volume, or switch to a desired track or disc.

In describing representative examples of the present invention, the specification may have presented the method and/or process of operating the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the examples described above without departing from the broad inventive concept thereof It is understood, therefore, that this invention is not limited to the particular examples disclosed, but it is intended to cover modifications within the spirit and scope of the present invention as defined by the appended claims.

We claim:

1. A control device capable of controlling an electronic device via wireless communications, the control device comprising:
a first antenna capable of receiving a radio frequency (RF) carrier at a first frequency;
a power generation circuit capable of converting RF power of the RF carrier into direct-current (DC) power;
a plurality of input devices configured to allow adjustment of a number of settings of the electronic device, each of the input devices being related to one of the number of settings;
a memory device configured to store a number of codes, each of the number of codes being related to one of the number of settings;
a control unit configured to receive the DC power and capable of retrieving one of the number of codes in the memory device based on a selection of at least one of the input devices; and
a modulator capable of modulating the one code at the first frequency.

2. The device of claim 1, wherein the power generation circuit includes a charge pump.

3. The device of claim 1, wherein the power generation circuit includes an alternating-current (AC) to DC converter and a voltage multiplier coupled to the AC to DC converter.

4. The device of claim 1, wherein the modulator transmits a modulated signal via the first antenna.

5. The device of claim 4, wherein the electronic device includes a second antenna configured to receive the modulated signal from the first antenna.

6. The device of claim 5, wherein the electronic device includes a demodulator capable of demodulating the modulated signal.

7. The device of claim 5, wherein the electronic device includes a transmitter capable of transmitting the RF carrier via the second antenna.

8. A control device capable of controlling an electronic device via wireless communications, the control device comprising:
a first antenna capable of receiving a carrier at a first frequency, the carrier having a first voltage level;
a power generation circuit capable of providing a power supply with a second voltage level based on the carrier, the second voltage level being greater than the first voltage level;
a number of input devices configured to allow adjustment of a number of settings of the electronic device, each of the number of input devices being related to one of the number of settings;
a memory device configured to store a number of codes, each of the number of codes being related to one of the number of settings;
a control unit configured to receive the power supply and capable of retrieving one of the number of codes in the memory device based on a selection of at least one of the input devices; and
a modulator capable of modulating the one code at the first frequency.

9. The device of claim 8, wherein the first antenna is capable of detecting the first frequency at one of an ultra high frequency (UHF) band and a microwave band.

10. The device of claim 8, wherein the power generation circuit includes a charge pump.

11. The device of claim 8, wherein the power generation circuit includes an alternating-current (AC) to DC converter and a voltage multiplier coupled to the AC to DC converter.

12. The device of claim 8, wherein the modulator transmits a modulated signal via the first antenna.

13. The device of claim 12, wherein the electronic device includes a second antenna configured to receive the modulated signal from the first antenna.

14. The device of claim 13, wherein the electronic device includes a demodulator capable of demodulating the modulated signal.

15. The device of claim 13, wherein the electronic device includes a transmitter capable of transmitting the carrier via the second antenna.

16. A control device capable of controlling an electronic device via wireless communications, the control device comprising:
a first antenna capable of receiving a carrier at a first frequency;
a power generation circuit capable of providing a power supply based on the carrier;
a number of input devices corresponding to a number of settings of the electronic device;
a memory device configured to store a number of codes, each of the number of codes being related to one of the number of settings;
a control unit coupled to the power generation circuit, the control unit being capable of retrieving one of the number of codes in the memory device based on a selection of at least one of the input devices; and
a modulator capable of modulating the one code at the first frequency.

17. The device of claim 16, wherein the power generation circuit includes a charge pump.

18. The device of claim 16, wherein the electronic device includes a second antenna configured to receive a modulated signal from the first antenna.

19. The device of claim 18, wherein the electronic device includes a demodulator capable of demodulating the modulated signal.

20. The device of claim 19, wherein the electronic device includes a transmitter capable of transmitting the carrier via the second antenna.
